(19) United States
(12) Patent Application Publication
(10) Pub. No.: US 2023/0399509 A1
(43) Pub. Date: Dec. 14, 2023

(54) POLYCARBONATE RESIN COMPOSITION, METHOD OF PREPARING THE SAME, AND MOLDED ARTICLE INCLUDING THE SAME

(71) Applicant: LG CHEM, LTD., Seoul (KR)

(72) Inventors: Su Kyoung LEE, Daejeon (KR); Woosoo CHOE, Daejeon (KR); Ryul LEE, Daejeon (KR); Minsu KIM, Daejeon (KR); Choongho KIM, Daejeon (KR); Young Wan KIM, Daejeon (KR); Hee Chan YANG, Daejeon (KR)

(21) Appl. No.: 18/110,758

(22) Filed: Feb. 16, 2023

(30) Foreign Application Priority Data
Jun. 8, 2022 (KR) 10-2022-0069351

(51) Int. Cl. C08L 69/00

(52) U.S. Cl. CPC C08L 69/00; C08L 2205/03; C08L 2205/025; C08L 2201/02

(57) ABSTRACT

The present disclosure relates to a polycarbonate resin composition including 8 to 25% by weight of a polycarbonate (A) having a melt index (300° C., 1.2 kg) of 5 to 15 g/10 min; 45 to 77% by weight of a polycarbonate (B) having a melt index (300° C., 1.2 kg) of greater than 15 g/10 min and 25 g/10 min or less; 8 to 25% by weight of a polysiloxane-polycarbonate copolymer (C); 4.5 to 9% by weight of a room-temperature liquid phosphorus-based flame retardant (D); and 1.5 to 5.5% by weight of a phosphazene compound (E), a method of preparing the polycarbonate resin composition, and a molded article including the polycarbonate resin composition.

### CROSS-REFERENCE TO RELATED APPLICATION(S)

This application claims priority under 35 U.S.C. 119(a) to Korean Patent Application No. 10-2022-0069351, filed on Jun. 8, 2022 in the Korean Intellectual Property Office, the entire content of which is incorporated herein by reference.

### TECHNICAL FIELD

The present disclosure relates to a polycarbonate resin composition, a method of preparing the same, and a molded article including the same. More particularly, the present disclosure relates to a polycarbonate resin composition containing a high content of a post-consumer recycled polycarbonate obtained by recycling plastics used and discarded by consumers and having excellent flame retardancy, impact resistance, and heat resistance, a method of preparing the polycarbonate resin composition, and a molded article including the polycarbonate resin composition.

### BACKGROUND

Plastics have been used in various fields for a long time due to various advantages including excellent productivity, light weight, and heat insulation, but due to structural characteristics thereof, plastics are not easily decomposed, causing environmental pollution when buried. Various studies are being conducted to solve these problems, and recycling is attracting attention thereamong. Recycling of waste plastics can solve the problem of environmental pollution and has the effect of significantly reducing costs.

The IT, electrical/electronic, and automotive industries are attempting to recycle plastics used and discarded by consumers in line with the eco-friendly trend. However, the mechanical properties of recycled plastics are inferior to those of conventional plastics, limiting use thereof.

Among various types of plastics, a polycarbonate is an amorphous and thermoplastic resin, has high impact resistance at room temperature, and has excellent thermal stability and transparency and high dimensional stability. Due to these advantages, polycarbonates are widely used in various industrial fields such as building materials, exterior materials and parts of electrical and electronic products, automobile parts, and optical parts.

However, since polycarbonates have low impact resistance at low temperatures and have no inherent flame retardant properties, there is a risk of fire when applied to electrical/electronic and automotive devices. To solve this problem, when a flame retardant is added to a polycarbonate, mechanical properties such as impact resistance and heat resistance are deteriorated.

In addition, when a post-consumer recycled polycarbonate is included in a thermoplastic resin composition, impact resistance and heat resistance are further deteriorated. Thus, the post-consumer recycled polycarbonate is used in a small amount.

Therefore, there is a need to develop a thermoplastic resin composition capable of increasing the ratio of a recycled resin by including a high content of a post-consumer recycled polycarbonate and imparting excellent flame retardancy, impact resistance, and heat resistance.

The background description provided herein is for the purpose of generally presenting context of the disclosure. Unless otherwise indicated herein, the materials described in this section are not prior art to the claims in this application and are not admitted to be prior art, or suggestions of the prior art, by inclusion in this section.

### DISCLOSURE

### Technical Problem

Therefore, the present disclosure has been made in view of the above problems, and it is one object of the present disclosure to provide a polycarbonate resin composition having excellent flame retardancy, impact resistance, and heat resistance while containing a high content of a post-consumer recycled polycarbonate.

It is another object of the present disclosure to provide a method of preparing the polycarbonate resin composition.

It is yet another object of the present disclosure to provide a molded article including the polycarbonate resin composition.

The above and other objects can be accomplished by the present disclosure described below.

### Technical Solution

In accordance with one aspect of the present disclosure, provided is a polycarbonate resin composition including 8 to 25% by weight of a polycarbonate (A) having a melt index (at 300° C., under a load of 1.2 kg) of 5 to 15 g/10 min; 45 to 77% by weight of a polycarbonate (B) having a melt index (at 300° C., under a load of 1.2 kg) of greater than 15 g/10 min and 25 g/10 min or less; 8 to 25% by weight of a polysiloxane-polycarbonate copolymer (C); 4.5 to 9% by weight of a room-temperature liquid phosphorus-based flame retardant (D); and 1.5 to 5.5% by weight of a phosphazene compound (E).

The polycarbonate (A) may be preferably a non-recycled polycarbonate, and the polycarbonate (B) may be preferably a post-consumer recycled polycarbonate.

Preferably, the polycarbonate resin composition may include 8 to 25% by weight of the non-recycled polycarbonate (A); 45 to 77% by weight of the post-consumer recycled polycarbonate (B); 8 to 25% by weight of the polysiloxane-polycarbonate copolymer (C); 4.5 to 9% by weight of the room-temperature liquid phosphorus-based flame retardant (D); and 1.5 to 5.5% by weight of the phosphazene compound (E).

Preferably, the polysiloxane-polycarbonate copolymer (C) may be obtained by introducing a polysiloxane into a polycarbonate main chain formed by polymerizing an aromatic diol compound and a carbonate precursor.

Preferably, the polysiloxane-polycarbonate copolymer (C) may include an aromatic polycarbonate-based first repeating unit represented by Chemical Formula 1 and an aromatic polycarbonate-based second repeating unit having one or more siloxane bonds represented by Chemical Formula 2; a repeating unit represented by Chemical Formula 3; or a mixture thereof:

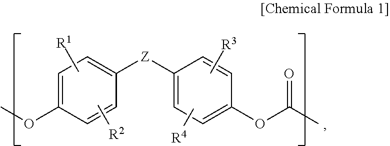

wherein R¹ to R⁴ are each independently selected from hydrogen; C₁₋₁₀ alkyl; C₁₋₁₀ alkoxy; and a halogen, and Z is selected from unsubstituted C₁₋₁₀ alkylene or C₁₋₁₀ alkylene substituted with C₁₋₆ alkyl or C₆₋₂₀ aryl; unsubstituted C₃₋₁₅ cycloalkylene or C₃₋₁₅ cycloalkylene substituted with C₁₋₁₀ alkyl; oxygen; S; SO; SO₂; and CO.

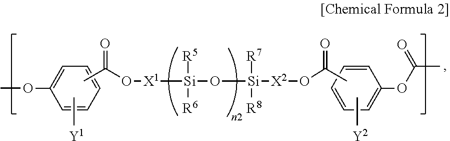

wherein X¹ and X² are each independently C₁₋₁₀ alkylene, Y¹ and Y² are each independently selected from hydrogen; C₁₋₆ alkyl; a halogen; a hydroxy group; a C₁₋₆ alkoxy group; and a C₆₋₂₀ aryl group, R⁵ to R⁸ are each independently selected from hydrogen; an unsubstituted C₁₋₁₅ alkyl; C₁₋₁₅ alkyl substituted with oxiranyl; C₁₋₁₅ alkyl substituted with a C₁₋₁₀ alkoxy group substituted with oxiranyl; C₁₋₁₅ alkyl substituted with C₆₋₂₀ aryl; a halogen; C₁₋₁₀ alkoxy; allyl; C₁₋₁₀ haloalkyl; and C₆₋₂₀ aryl, and n2 is an integer from 30 to 120.

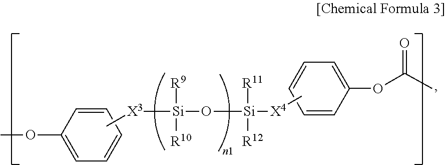

wherein X³ and X⁴ are each independently C₁₋₁₀ alkylene, R⁹ to R¹² are each independently hydrogen; an unsubstituted C₁₋₁₅ alkyl; C₁₋₁₅ alkyl substituted with oxiranyl; C₁₋₁₅ alkyl substituted with a C₁₋₁₀ alkoxy group substituted with oxiranyl; C₁₋₁₅ alkyl substituted with C₆₋₂₀ aryl; a halogen; C₁₋₁₀ alkoxy; allyl; C₁₋₁₀ haloalkyl; or C₆₋₂₀ aryl, and n1 is an integer from 30 to 120.

Preferably, the polysiloxane-polycarbonate copolymer (C) may have siloxane domains having an average size of 20 nm or more.

Preferably, the room-temperature liquid phosphorus-based flame retardant (D) may include one or more selected from the group consisting of bisphenol-A-diphenyl phosphate (BPADP), triphenyl phosphate (TPP), and resorcinol bis (diphenyl phosphate) (RDP).

Preferably, the phosphazene compound (E) may include one or more selected from the group consisting of a cyclic phosphazene compound, an acyclic phosphazene compound, and a cross-linked phosphazene compound.

Preferably, a weight ratio (D:E) of the room-temperature liquid phosphorus-based flame retardant (D) to the phosphazene compound (E) may be 5.5:4.5 to 9:1.

Preferably, the polycarbonate resin composition may include one or more additives selected from the group consisting of a heat stabilizer, a flame retardant aid, a lubricant, a processing aid, a plasticizer, a coupling agent, a light stabilizer, a release agent, a dispersant, an anti-dripping agent, a weathering stabilizer, an antioxidant, a compatibilizer, a pigment, a dye, an antistatic agent, an anti-wear agent, a filler, and an antibacterial agent.

Preferably, the polycarbonate resin composition may have an Izod impact strength of 67 kgf-cm/cm or more at room temperature (20±5° C.) and an Izod impact strength of 17 kgf-cm/cm or more at low temperature (−30° C.) as measured using a notched specimen having a thickness of 3.2 mm according to ASTM D256.

Preferably, the polycarbonate resin composition may have a heat deflection temperature of 98° C. or higher as measured under a load of 18.6 kg using a specimen having a thickness of 6.4 mm according to ASTM D648.

Preferably, the polycarbonate resin composition may have a flame retardancy of grade V-0 or higher as measured using a specimen having a thickness of 0.8 mm according to a UL94 V test.

In accordance with another aspect of the present disclosure, provided is a method of preparing a polycarbonate resin composition, the method including kneading and extruding 8 to 25% by weight of a polycarbonate (A) having a melt index (300° C., 1.2 kg) of 5 to 15 g/10 min, 45 to 77% by weight of a polycarbonate (B) having a melt index (300° C., 1.2 kg) of greater than 15 g/10 min and 25 g/10 min or less, 8 to 25% by weight of a polysiloxane-polycarbonate copolymer (C), 4.5 to 9% by weight of a room-temperature liquid phosphorus-based flame retardant (D), and 1.5 to 5.5% by weight of a phosphazene compound (E) at 200 to 350° C. and 100 to 400 rpm.

Preferably, the method of preparing a polycarbonate resin composition may include kneading and extruding 8 to 25% by weight of the general polycarbonate (A), 45 to 77% by weight of the post-consumer recycled polycarbonate (B), 8 to 25% by weight of the polysiloxane-polycarbonate copolymer (C), 4.5 to 9% by weight of the room-temperature liquid phosphorus-based flame retardant (D), and 1.5 to 5.5% by weight of the phosphazene compound (E) at 200 to 350° C. and 100 to 400 rpm.

In accordance with yet another aspect of the present disclosure, provided is a molded article including the polycarbonate resin composition.

### Advantageous Effects

According to the present disclosure, the present disclosure has an effect of providing a polycarbonate resin composition having excellent flame retardancy, heat resistance, and impact resistance even though containing a high content of a post-consumer recycled polycarbonate.

In addition, since the polycarbonate resin composition according to the present disclosure contains a post-consumer recycled polycarbonate in a high content, it can increase a recycling rate of waste plastic. Accordingly, it provides profits of being eco-friendly, reducing greenhouse gases, and saving energy.

### DETAILED DESCRIPTION

Hereinafter, a polycarbonate resin composition of the present disclosure will be described in detail.

The present inventors confirmed that, when a post-consumer recycled polycarbonate was included in a high content in a polycarbonate, and a room-temperature liquid phosphorus-based flame retardant, a phosphazene compound, and a polysiloxane-polycarbonate copolymer were included in a predetermined content ratio, flame retardancy, heat resistance, and impact strength at room temperature and low temperature were excellent. Based on these results, the present inventors conducted further studies to complete the present disclosure.

The polycarbonate resin composition according to the present disclosure is described in detail as follows.

The polycarbonate resin composition of the present disclosure includes 8 to 25% by weight of a polycarbonate (A) having a melt index (300° C., 1.2 kg) of 5 to 15 g/10 min; 45 to 77% by weight of a polycarbonate (B) having a melt index (300° C., 1.2 kg) of greater than 15 g/10 min and 25 g/10 min or less; 8 to 25% by weight of a polysiloxane-polycarbonate copolymer (C); 4.5 to 9% by weight of a room-temperature liquid phosphorus-based flame retardant (D); and 1.5 to 5.5% by weight of a phosphazene compound (E). In this case, while including a high content of recycled polycarbonate, excellent flame retardancy, impact resistance, and heat resistance may be implemented, and eco-friendliness may be achieved.

A) Polycarbonate Having Melt Index (300° C., 1.2 Kg) of 5 to 15 g/10 Min

For example, the polycarbonate (A) may have a melt index (300° C., 1.2 kg) of 5 to 15 g/10 min, preferably 7 to 12 g/10 min, more preferably 9 to 11 g/10 min. Within this range, mechanical properties and heat resistance may be excellent.

In the present disclosure, the melt index is measured at 300° C. under a load of 1.2 kg according to ASTM D1238.

For example, the polycarbonate (A) may have a polydispersity index of 2.75 or less, preferably 2.6 or less, more preferably 2.5 or less, still more preferably 2.3 to 2.5. Within this range, mechanical properties and physical property balance may be excellent.

In the present disclosure, the polydispersity index refers to the distribution of molecular weights and is calculated by dividing a weight average molecular weight by a number average molecular weight. A large polydispersity index indicates that the standard deviation of a molecular weight distribution is large, i.e., that there are many molecular weights greater or less than a weight average molecular weight.

In the present disclosure, unless otherwise defined, the weight average molecular weight and the number average molecular weight may be measured using tetrahydrofuran (THF) as an eluate through gel permeation chromatography (GPC, Waters Breeze). In this case, the weight average molecular weight or the number average molecular weight is obtained as a relative value to a polystyrene (PS) standard sample.

Specific measurement conditions are as follows: solvent: THF, column temperature: 40° C., flow rate: 0.3 ml/min, sample concentration: 20 mg/ml, injection amount: 5 μl, column model: 1×PLgel 10 μm MiniMix-B (250×4.6 mm)+1×PLgel 10 μm MiniMix-B (250×4.6 mm)+1×PLgel 10 μm MiniMix-B Guard (50×4.6 mm), equipment name: Agilent 1200 series system, refractive index detector: Agilent G1362 RID, RI temperature: 35° C., data processing: Agilent ChemStation S/W, and test method (Mn, Mw and PDI): OECD TG 118.

For example, the polycarbonate (A) may have a heat deflection temperature of 124° C. or higher, preferably 127° C. or higher, more preferably 130° C. or higher, still more preferably 130 to 140° C. as measured according to ASTM D648. Within this range, mechanical properties and physical property balance may be excellent.

In the present disclosure, the heat deflection temperature may be measured under a load of 18.6 kg using a specimen having a thickness of 6.4 mm according to ASTM D648.

For example, the polycarbonate (A) may have a weight average molecular weight of 28,000 g/mol or more, preferably 29,000 g/mol or more, more preferably 30,000 g/mol or more, still more preferably 30,000 to 37,000 g/mol. Within this range, mechanical properties and physical property balance may be excellent.

For example, the polycarbonate (A) may be a non-recycled polycarbonate.

In the present disclosure, a non-recycled polycarbonate commonly accepted in the art to which the present disclosure pertains may be used in the present disclosure without particular limitation as long as the non-recycled polycarbonate follows the definition of the present disclosure. The non-recycled polycarbonate contrasts with the post-consumer recycled polycarbonate of the present disclosure, and may be a polycarbonate that has not been subjected to molding processing such as injection after polymerization of monomers constituting the polycarbonate or a commercially available polycarbonate corresponding to the polycarbonate.

For example, the non-recycled polycarbonate may be referred to as a virgin polycarbonate, a fresh polycarbonate, or a general polycarbonate.

For example, based on a total weight of the components (A), (B), (C), (D), and (E), the polycarbonate (A) may be included in an amount of 8 to 25% by weight, preferably 10 to 22% by weight, more preferably 11 to 19% by weight, still more preferably 14 to 17% by weight. Within this range, impact resistance and heat resistance may be excellent.

For example, the polycarbonate (A) may be a resin prepared by polymerizing an aromatic diol compound and a carbonate precursor.

For example, the aromatic diol compound may include one or more selected from the group consisting of bis(4-hydroxyphenyl)methane, bis(4-hydroxyphenyl)ether, bis(4-hydroxyphenyl)sulfone, bis(4-hydroxyphenyl)sulfoxide, bis(4-hydroxyphenyl)sulfide, bis (4-hydroxyphenyl)ketone, 1,1-bis(4-hydroxyphenyl)ethane, 2,2-bis(4-hydroxyphenyl)propane (bisphenol A; BPA), 2,2-bis(4-hydroxyphenyl)butane, 1,1-bis (4-hydroxyphenyl)cyclohexane (bisphenol Z; BPZ), 2,2-bis(4-hydroxy-3,5-dibromophenyl)propane, 2,2-bis(4-hydroxy-3,5-dichlorophenyl)propane, 2,2-bis(4-hydroxy-3-bromophenyl)propane, 2,2-bis(4-hydroxy-3-chlorophenyl)propane, 2,2-bis(4-hydroxy-3-methylphenyl)propane, 2,2-bis(4-hydroxy-3,5-dimethylphenyl)propane, 1,1-bis(4-hydroxyphenyl)-1-phenylethane, bis(4-hydroxyphenyl)diphenylmethane, and α,ω-bis[3-(o-hydroxyphenyl)propyl]polydimethylsiloxane, preferably bisphenol A.

For example, the carbonate precursor may include one or more selected from the group consisting of dimethyl carbonate, diethyl carbonate, dibutyl carbonate, dicyclohexyl carbonate, diphenyl carbonate, ditolyl carbonate, bis(chlorophenyl) carbonate, m-cresyl carbonate, dinaphthyl carbonate, bis (diphenyl) carbonate, carbonyl chloride (phosgene), triphosgene, diphosgene, carbonyl bromide, and bishaloformate. Considering production efficiency and physical properties, triphosgene, phosgene, or a mixture thereof is preferably used.

As a specific example, the polycarbonate formed by polymerizing the aromatic diol compound and the carbonate precursor includes a repeating unit represented by Chemical Formula 4 below.

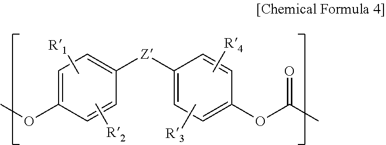

In Chemical Formula 4, R′₁ to R′₄ are each independently selected from hydrogen, C₁₋₁₀ alkyl, C₁₋₁₀ alkoxy, and a halogen, and Z′ is selected from unsubstituted C₁₋₁₀ alkylene or C₁₋₁₀ alkylene substituted with C₁₋₆ alkyl or C₆₋₂₀ aryl; unsubstituted C₃₋₁₅ cycloalkylene or C₃₋₁₅ cycloalkylene substituted with C₁₋₁₀ alkyl; O; S; SO; SO₂; and CO.

Preferably, in Chemical Formula 4, R′₁ to R′₄ may each independently be hydrogen or C₁₋₃ alkyl, and Z′ may be unsubstituted C₁₋₆ alkylene or C₁₋₆ alkylene substituted with methyl or phenyl.

For example, the polycarbonate (A) may include one or more selected from the group consisting of a linear polycarbonate, a branched polycarbonate, and a polyester carbonate copolymer, preferably a linear polycarbonate. In this case, fluidity may be improved, and appearance characteristics may be excellent.

The linear polycarbonate resin may preferably be a bisphenol-A polycarbonate, but the present disclosure is not limited thereto.

B) Polycarbonate Having Melt Index (300° C., 1.2 Kg) of Greater than 15 g/10 Min and 25 g/10 Min or Less

The polycarbonate (B) may have a melt index of preferably 17 to 22 g/10 min, more preferably 19 to 21 g/10 min. Within this range, physical property balance and impact resistance may be excellent.

For example, the polycarbonate (B) may have a polydispersity index of greater than 2.75, preferably 2.8 or more, more preferably 2.8 to 3.2, still more preferably 2.8 to 3. Within this range, mechanical properties and physical property balance may be excellent.

For example, the polycarbonate (B) may have a heat deflection temperature of less than 124° C., preferably 122° C. or less, more preferably 115 to 122° C. as measured according to ASTM D648. Within this range, mechanical properties and physical property balance may be excellent.

For example, the polycarbonate (B) may have a weight average molecular weight of 20,000 g/mol or more and less than 28,000 g/mol, preferably 22,000 to 27,000 g/mol, more preferably 24,000 to 27,000 g/mol. Within this range, mechanical properties and physical property balance may be excellent.

For example, the polycarbonate (B) may be a post-consumer recycled polycarbonate. In this case, by recycling waste plastics, effects of being environmentally friendly, saving energy and water, and reducing carbon emission may be obtained.

In the present disclosure, a post-consumer recycled polycarbonate commonly accepted in the art to which the present disclosure pertains may be used in the present disclosure without particular limitation as long as the post-consumer recycled polycarbonate follows the definition of the present disclosure. For example, the post-consumer recycled polycarbonate is a polycarbonate recycled from collected waste plastics. As a specific example, the post-consumer recycled polycarbonate refers to a raw material obtained by sorting, washing, and crushing collected waste plastics. In addition, when necessary, the post-consumer recycled polycarbonate may be processed into pellets through an extrusion process. In this case, no additional processing such as additional purification is required. Since the post-consumer recycled polycarbonate has been processed one or more times, additives such as a colorant, a lubricant, and/or a release agent may be included.

For example, the post-consumer recycled polycarbonate may also be referred to as a recycled polycarbonate.

Since all physical properties such as impact resistance, heat resistance, and flame retardancy of the post-consumer recycled polycarbonate (B) are inferior to those of the polycarbonate (A), conventionally, a post-consumer recycled polycarbonate was contained in a small amount of 30% by weight or less in a polycarbonate resin composition.

However, even though the polycarbonate resin composition of the present disclosure includes an excess (50% by weight or more) of a post-consumer recycled polycarbonate, flame retardancy, impact resistance, and heat resistance are excellent, and recycling rate is high.

The monomers constituting the polycarbonate (B) may be preferably selected within the same range as mentioned for the polycarbonate (A).

For example, a commercially available polycarbonate may be used as the polycarbonate (B) as long as the commercially available polycarbonate follows the definition of the present disclosure.

For example, based on a total weight of the components (A), (B), (C), (D), and (E), the polycarbonate (B) may be included in an amount of 45 to 77% by weight, preferably 50 to 70% by weight, more preferably 55 to 65% by weight, still more preferably 57 to 63% by weight. Within this range, due to high recycling rate, eco-friendliness may be increased, water and energy consumption may be reduced, and flame retardancy, heat resistance, and impact resistance may be excellent.

C) Polycarbonate-Polysiloxane Copolymer

For example, the polysiloxane-polycarbonate copolymer (C) may be obtained by introducing a polysiloxane into a polycarbonate main chain formed by polymerizing an aromatic diol compound and a carbonate precursor. In this case, impact resistance may be improved.

In the present disclosure, the polysiloxane-polycarbonate copolymer (C) is distinguished from the polycarbonate (A) in that a polysiloxane is introduced into the polycarbonate main chain thereof.

For example, the aromatic diol compound and the carbonate precursor may be the same as those used in preparing the polycarbonate (A).

For example, the polysiloxane-polycarbonate copolymer (C) may be prepared by condensation polymerization of a polycarbonate and a polysiloxane or by interfacial polymerization of an aromatic diol compound, a carbonate precursor, and a polysiloxane, but the present disclosure is not limited thereto.

For example, the polysiloxane-polycarbonate copolymer (C) includes an aromatic polycarbonate-based first repeating unit represented by Chemical Formula 1 below; and an aromatic polycarbonate-based second repeating unit represented by Chemical Formula 2 below and having one or more siloxane bonds.

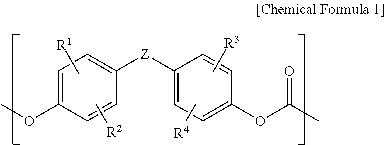

In Chemical Formula 1, R¹ to R⁴ are each independently selected from hydrogen; C₁₋₁₀ alkyl; C₁₋₁₀ alkoxy; and a halogen, and Z is selected from unsubstituted C₁₋₁₀ alkylene or C₁₋₁₀ alkylene substituted with C₁₋₆ alkyl or C₆₋₂₀ aryl; unsubstituted C₃₋₁₅ cycloalkylene or C₃₋₁₅ cycloalkylene substituted with C₁₋₁₀ alkyl; oxygen; S; SO; SO₂; and CO.

Preferably, in Chemical Formula 1, R₁ to R₄ may each independently be hydrogen or C₁₋₃ alkyl, and Z may be unsubstituted C₁₋₆ alkylene or C₁₋₆ alkylene substituted with methyl or phenyl.

Preferably, the first repeating unit represented by Chemical Formula 1 is obtained by polymerization of a bisphenol A, which is an aromatic diol compound, and triphosgene, which is a carbonate precursor, and is represented by Chemical Formula 1-1 below.

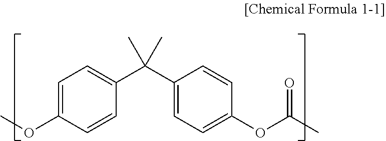

For example, the first repeating unit represented by Chemical Formula 1 may be included in the polysiloxane-polycarbonate copolymer in an amount of 30 mol % or more, preferably 50 mol % or more, more preferably 70 mol % or more, still more preferably 70 to 95 mol %.

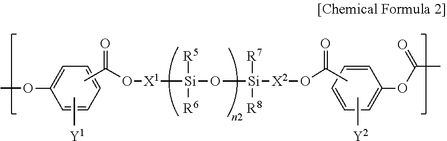

In Chemical Formula 2, X¹ and X² are each independently C₁₋₁₀ alkylene, Y¹ and Y² are each independently selected from hydrogen; C₁₋₆ alkyl; a halogen; a hydroxy group; a C₁₋₆ alkoxy group; and a C₆₋₂₀ aryl group, R⁵ to R⁸ are each independently selected from hydrogen; an unsubstituted C₁₋₁₅ alkyl; C₁₋₁₅ alkyl substituted with oxiranyl; C₁₋₁₅ alkyl substituted with a C₁₋₁₀ alkoxy group substituted with oxiranyl; C₁₋₁₅ alkyl substituted with C₆₋₂₀ aryl; a halogen; C₁₋₁₀ alkoxy; allyl; C₁₋₁₀ haloalkyl; and C₆₋₂₀ aryl, and n2 is an integer from 30 to 120. Preferably, in Chemical Formula 2, X¹ and X² may each independently be C₂₋₁₀ alkylene, more preferably C₂₋₆ alkylene, most preferably isobutylene, and Y¹ and Y² may each independently be hydrogen.

More preferably, in Chemical Formula 2, R⁵ to R⁸ may each independently be hydrogen, methyl, ethyl, propyl, 3-phenylpropyl, 2-phenylpropyl, 3-(oxiranylmethoxy)propyl, fluoro, chloro, bromo, iodo, methoxy, ethoxy, propoxy, allyl, 2,2,2-trifluoroethyl, 3,3,3-trifluoropropyl, phenyl, or naphthyl.

More preferably, R⁵ to R⁸ may each independently be C₁₋₁₀ alkyl or C₁₋₆ alkyl, still more preferably C₁₋₃ alkyl, still more preferably methyl.

In addition, in Chemical Formula 2, n2 may be an integer from 30 to 120, preferably an integer from 34 to 110.

The repeating unit represented by Chemical Formula 2 is preferably represented by Chemical Formula 2-1 below.

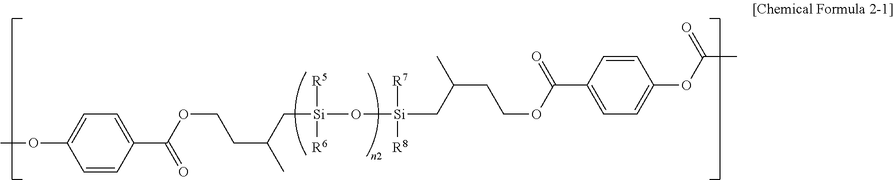

In Chemical Formula 2-1, R⁵ to R⁸ and n2 are the same as defined above.

For example, the repeating unit represented by Chemical Formula 2 may be included in the polysiloxane-polycarbonate copolymer in an amount of 1 mol % or more, preferably 5 mol % or more, more preferably 30 mol % or more, still more preferably 50 mol % or more, still more preferably 70 mol % or more, still more preferably 70 to 95 mol %.

Preferably, the polysiloxane-polycarbonate copolymer may further include a repeating unit represented by Chemical Formula 3 below.

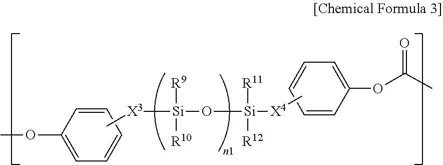

In Chemical Formula 3, X³ and X⁴ are each independently C₁₋₁₀ alkylene, R⁹ to R¹² are each independently hydrogen; an unsubstituted C₁₋₁₅ alkyl; C₁₋₁₅ alkyl substituted with oxiranyl; C₁₋₁₅ alkyl substituted with a C₁₋₁₀ alkoxy group substituted with oxiranyl; C₁₋₁₅ alkyl substituted with C₆₋₂₀ aryl; a halogen; C₁₋₁₀ alkoxy; allyl; C₁₋₁₀ haloalkyl; or C₆₋₂₀ aryl, and n1 is an integer from 30 to 120.

Preferably, in Chemical Formula 3, X³ and X⁴ may each independently be C₂₋₁₀ alkylene, preferably C₂₋₄ alkylene, more preferably propane-1,3-diyl.

In Chemical Formula 3, R⁹ to R¹² may each independently be hydrogen, methyl, ethyl, propyl, 3-phenylpropyl, 2-phenylpropyl, 3-(oxiranylmethoxy)propyl, fluoro, chloro, bromo, iodo, methoxy, ethoxy, propoxy, allyl, 2,2,2-trifluoroethyl, 3,3,3-trifluoropropyl, phenyl, or naphthyl.

Preferably, R⁹ to R¹² are each independently C₁₋₁₀ alkyl or C₁₋₆ alkyl, more preferably C₁₋₃ alkyl, still more preferably methyl.

In addition, in Chemical Formula 3, n1 is an integer from 30 to 120, preferably an integer from 34 to 110.

When the repeating unit represented by Chemical Formula 3 is further included, the heat resistance and impact resistance of the composition may be further improved.

The repeating unit represented by Chemical Formula 3 is preferably represented by Chemical Formula 3-1 below.

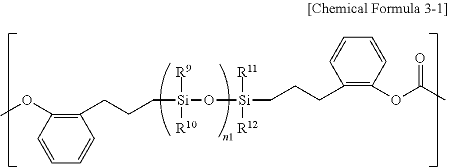

In Chemical Formula 3-1, R⁹ to R¹² and n1 are the same as defined above.

For example, the repeating unit represented by Chemical Formula 3 may be included in the polysiloxane-polycarbonate copolymer in an amount of 1 mol % or more, preferably 5 mol % or more, more preferably 30 mol % or more, still more preferably 50 mol % or more, still more preferably 70 mol % or more, still more preferably 70 to 95 mol %.

For example, the polysiloxane-polycarbonate copolymer (C) may have a weight average molecular weight of 1,000 to 100,000 g/mol, preferably 5,000 to 70,000 g/mol, more preferably 5,000 to 50,000 g/mol.

Within this range, processing and molding of the composition may be easy, and impact resistance and heat resistance may be satisfied at the same time.

For example, the polysiloxane-polycarbonate copolymer (C) may have siloxane domains having an average size of 20 nm or more, preferably 20 to 60 nm, more preferably 40 to 60 nm. Within this range, the siloxane domains of the polysiloxane-polycarbonate copolymer may play a role as an impact modifier such as rubber to greatly increase impact resistance.

In the present disclosure, the term “domain” means another unit chain dispersed in a matrix chain.

In addition, the “average size of siloxane domains” refers to the average size of polysiloxane chains dispersed in polycarbonate chains. Specifically, the “average size of siloxane domains” may refer to the average size of polysiloxane chains, more specifically, polysiloxane aggregates, dispersed in polycarbonate chains as a matrix.

For example, in the present disclosure, the average size of siloxane domains may be measured by shape analysis using a microscope. As a specific example, the average size of siloxane domains may be measured at room temperature using a scanning electron microscope (SEM) or a transmission electron microscope (TEM). Preferably, when the average size of siloxane domains is measured, ten siloxane domains are randomly selected from an image taken using a microscope, the sizes thereof are measured, and an average value for the measured values is calculated.

For example, based on a total weight of the components (A), (B), (C), (D), and (E), the polysiloxane-polycarbonate copolymer (C) may be included in an amount of 8 to 25% by weight, preferably 10 to 23% by weight, more preferably 12 to 21% by weight, still more preferably 12 to 17% by weight. Within this range, physical property balance and impact resistance may be improved.

D) Room-Temperature Liquid Phosphorus-Based Flame Retardant

For example, based on a total weight of the components (A), (B), (C), (D), and (E), the room-temperature liquid phosphorus-based flame retardant (D) may be included in an amount of 4.5 to 9% by weight, preferably 5 to 8.5% by weight, more preferably 5 to 8% by weight, still more preferably 5.5 to 7.5% by weight. Within this range, impact resistance, heat resistance, and flame retardancy may be excellent, and a molded article having an aesthetically pleasing appearance may be obtained.

The room-temperature liquid phosphorus-based flame retardant (D) maintains a liquid phase at room temperature, more specifically, at room temperature under atmospheric pressure. The room-temperature liquid phosphorus-based flame retardant (D) plays a role in imparting flame retardancy to the resin composition according to the present disclosure and controlling melt index. Accordingly, even when the resin composition according to the present disclosure contains a minimum amount of flame retardant, flame Retardancy may be stably implemented, simultaneously productivity may be improved, and appearance characteristics and processability of the obtained molded article may be improved. In addition, when the room-temperature liquid phosphorus-based flame retardant (D) is combined with the phosphazene compound (E) to be described later, flame retardancy of grade V-0 or higher may be secured, and impact resistance and heat resistance may be further improved through a synergistic effect.

In the present disclosure, room temperature may be at any point in the range of 20±5° C.

For example, the room-temperature liquid phosphorus-based flame retardant (D) may include one or more selected from the group consisting of bisphenol-A-diphenyl phosphate (BPADP), triphenyl phosphate (TPP), and resorcinol bis(diphenyl phosphate) (RDP), preferably bisphenol-A-diphenyl phosphate. In this case, impact resistance and heat resistance may be excellent, and flame retardancy may be secured.

E) Phosphazene Compound

For example, based on a total weight of the components (A), (B), (C), (D), and (E), the phosphazene compound (E) may be included in an amount of 1.5 to 5.5% by weight, preferably 2 to 5% by weight, more preferably 2.5 to 4.5% by weight, still more preferably 3 to 4.5% by weight. Within this range, by combining with the room-temperature liquid phosphorus-based flame retardant (D), flame retardancy may be secured, and impact resistance and heat resistance may be further improved.

For example, the phosphazene compound (E) is an organic compound having a molecular bond of —P═N—. Preferably, the phosphazene compound (E) may include one or more selected from the group consisting of a cyclic phosphazene compound, an acyclic phosphazene compound, and a cross-linked phosphazene compound, more preferably a cyclic phosphazene compound. In this case, flame retardancy and mechanical properties may be excellent.

The cyclic phosphazene compound may be preferably a compound represented by Chemical Formula 5 below.

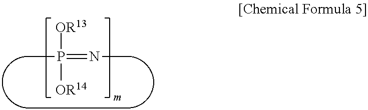

In Chemical Formula 5, m is an integer from 3 to 25, and R¹³ and R¹⁴ are the same or different and represent an aryl group or an alkylaryl group.

In Chemical Formula 5, m is preferably an integer from 3 to 5.

Preferably, the cyclic phosphazene compound represented by Chemical Formula 5 may be a cyclic phenoxyphosphazene in which R¹³ and R¹⁴ are phenyl groups. More preferably, the cyclic phosphazene compound may include one or more selected from the group consisting of phenoxycyclotriphosphazene, octaphenoxycyclotetraphosphazene, and decaphenoxycyclopentaphosphazene.

The acyclic phosphazene compound may be preferably a compound represented by Chemical Formula 6 below.

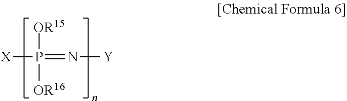

In Chemical Formula 6, n is an integer from 3 to 10,000, X represents a —N═P (OR¹⁵)₃ group or a —N═P(O)OR¹⁵ group, and Y represents a —P(OR¹⁶)₄ group or a —P(O)(OR¹⁶)₂ group. R¹⁵ and R¹⁶ are the same or different and represent an aryl group or an alkylaryl group.

In Chemical Formula 6, n is preferably an integer from 3 to 100, more preferably an integer from 3 to 25.

The acyclic phosphazene compound represented by Chemical Formula 6 is preferably an acyclic phenoxyphosphazene in which R¹⁵ and R¹⁶ are phenyl groups.

For example, the cross-linked phosphazene compound may be obtained by crosslinking one or more phosphazene compounds selected from the group consisting of a cyclic phosphazene compound and an acyclic phosphazene compound with a crosslinking group represented by Chemical Formula 7 below.

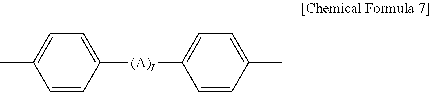

In Chemical Formula 7, A is —C(CH₃)₂—, —SO₂—, —S—, or —O—, and I is an integer of 0 or 1.

Preferably, the cross-linked phosphazene compound may be a cross-linked phenoxyphosphazene compound obtained by crosslinking a cyclic phenoxyphosphazene compound in which R¹³ and R¹⁴ are phenyl groups in Chemical Formula 5 with the crosslinking group represented by Chemical Formula 7, a cross-linked phenoxyphosphazene compound obtained by crosslinking an acyclic phenoxyphosphazene compound in which R¹⁵ and R¹⁶ are phenyl groups in Chemical Formula 6 with the crosslinking group represented by Chemical Formula 7, or a mixture thereof, more preferably a cross-linked phenoxyphosphazene compound obtained by crosslinking a cyclic phenoxyphosphazene compound with the crosslinking group represented by Chemical Formula 7.

When the room-temperature liquid phosphorus-based flame retardant (D) is combined with the phosphazene compound (E), due to the synergistic effect thereof, flame retardancy of grade V-0 or higher may be implemented, and impact resistance and heat resistance may be greatly improved.

For example, the room-temperature liquid phosphorus-based flame retardant (D) may be included in a greater amount than the phosphazene compound (E).

In this case, excellent flame retardancy may be achieved by using a small amount of flame retardant.

For example, the weight ratio (D:E) of the room-temperature liquid phosphorus-based flame retardant (D) to the phosphazene compound (E) may be 5.5:4.5 to 9:1, preferably 6:4 to 8.5:1.5, more preferably 6:4 to 8:2, still more preferably 6:4 to 7:3. Within this range, excellent flame retardancy may be achieved by using a small amount of flame retardant, and impact resistance and heat resistance may be excellent.

For example, a total weight of the room-temperature liquid phosphorus-based flame retardant (D) and the phosphazene compound (E) may be 7 to 14% by weight, preferably 7.5 to 13% by weight, more preferably 8 to 12% by weight, still more preferably 8.5 to 11% by weight. Within this range, flame retardancy, impact resistance, and heat resistance may be significantly improved.

For example, the polycarbonate resin composition may be a core-shell structured impact modifier-free composition. In this case, by combining the room-temperature liquid phosphorus-based flame retardant (D) with the phosphazene compound (E), impact resistance and heat resistance may be excellent, and flame retardancy may be further improved.

In the present disclosure, the term “core-shell structured impact modifier-free” means that a core-shell structured impact modifier is not included, and for example, may mean that a core-shell structured impact modifier is not intentionally added when preparing a polycarbonate resin composition.

For example, the polycarbonate resin composition may include one or more additives selected from the group consisting of a heat stabilizer, a flame retardant aid, a lubricant, a processing aid, a plasticizer, a coupling agent, a light stabilizer, a release agent, a dispersant, an anti-dripping agent, a weathering stabilizer, an antioxidant, a compatibilizer, a pigment, a dye, an antistatic agent, an anti-wear agent, a filler, and an antibacterial agent. In this case, required physical properties may be well implemented without deteriorating the inherent physical properties of the polycarbonate resin composition of the present disclosure.

Based on 100 parts by weight in total of the components (A), (B), (C), (D), and (E), each of the additives may be included in an amount of 0.01 to 20 parts by weight, preferably 0.05 to 10 parts by weight, more preferably 0.1 to 5 parts by weight. In this case, required physical properties may be well implemented without deteriorating the inherent physical properties of the polycarbonate resin composition of the present disclosure.

For example, the heat stabilizer may include one or more selected from the group consisting of a hindered phenol-based heat stabilizer, a diphenyl amine-based heat stabilizer, a sulfur-based heat stabilizer, and a phosphorus-based heat stabilizer, preferably a hindered phenol-based heat stabilizer, a phosphorus-based heat stabilizer, or a mixture thereof. In this case, oxidation by heat may be prevented during an extrusion process, and thus mechanical properties may be excellent.

For example, the hindered phenol-based heat stabilizer may be pentaerythritol tetrakis[3-(3,5-di-t-butyl-4-hydroxyphenyl)propionate], 1,3,5-trimethyl-2,4,6-tris(3,5-di-t-butyl-4-hydroxybenzyl)benzene, or a mixture thereof, preferably pentaerythritol tetrakis[3-(3,5-di-t-butyl-4-hydroxyphenyl)propionate].

For example, the diphenyl amine-based heat stabilizer may include one or more selected from the group consisting of phenylnaphthylamine, 4,4′-dimethoxy diphenyl amine, 4,4′-bis (α,α-dimethylbenzyl) diphenyl amine, and 4-isopropoxy diphenyl amine.

For example, the sulfur-based heat stabilizer may include one or more selected from the group consisting of dilauryl-3,3′-thiodipropionic acid ester, dimyristyl-3,3′-thiodipropionic acid ester, distearyl-3,3′-thiodipropionic acid ester, laurylstearyl-3,3′-thiodipropionic acid ester, and pentaerythritol tetrakis(3-laurylthio propion ester), without being limited thereto.

For example, the phosphorus-based heat stabilizer may include one or more selected from the group consisting of tris(mixed, mono, and ginolyrphenyl) phosphite, tris(2,3-di-t-butylphenyl) phosphite, 4,4′-butylidene bis(3-methyl-6-t-butylphenyl-di-tridecyl) phosphite, 1,1,3-tris(2-methyl-4-di-tridecyl phosphite-5-t-butylphenyl) butane, bis (2,4-di-t-butylphenyl) pentaerythritol-di-phosphite, tetrakis (2,4-di-t-butylphenyl)-4,4′-biphenylene diphosphonate, bis (2,6-di-t-butyl-4-methylphenyl) pentaerythritol-di-phosphite, 2,2′-ethylidene bis(4,6-di-t-butylphenyl)-2-ethylhexyl-phosphite, bis(2,4,6-di-t-butylphenyl) pentaerythritol-di-phosphite, triphenylphosphite, diphenyldecyl phosphite, didecyl phenyl phosphite, tridecyl phosphite, trioctyl phosphite, tridodecyl phosphite, trioctadecyl phosphite, trinonylphenyl phosphite, and tridodecyl trithiophosphite, preferably bis(2,6-di-t-butyl-4-methylphenyl) pentaerythritol-di-phosphite, without being limited thereto.

For example, the lubricant may include one or more selected from the group consisting of modified montanic acid wax, a long chain ester of pentaerythritol, and a fatty acid ester of neopentylpolyol.

For example, the UV absorber may include one or more selected from the group consisting of a triazine-based UV absorber, a benzophenone-based UV absorber, a benzotriazole-based UV absorber, a benzoate-based UV absorber, and a cyanoacrylate-based UV absorber.

For example, the triazine-based UV absorber may include one or more selected from the group consisting of 2,4-diphenyl-6-(2-hydroxy-4-methoxyphenyl)-1,3,5-triazine, 2,4-diphenyl-6-(2-hydroxy-4-ethoxyphenyl)-1,3,5-triazine, 2,4-diphenyl-(2-hydroxy-4-propoxyphenyl)-1,3,5-triazine, 2,4-diphenyl-(2-hydroxy-4-butoxyphenyl)-1,3,5-triazine, 2,4-diphenyl-6-(2-hydroxy-4-butoxyphenyl)-1,3,5-triazine, 2,4-diphenyl-6-(2-hydroxy-4-hexyloxyphenyl)-1,3,5-triazine, 2,4-diphenyl-6-(2-hydroxy-4-octyloxyphenyl)-1,3,5-triazine, 2,4-diphenyl-6-(2-hydroxy-4-dodecyloxyphenyl)-1,3,5-triazine, and 2,4-diphenyl-6-(2-hydroxy-4-benzyloxyphenyl)-1,3,5-triazine.

For example, the benzophenone-based UV absorber may include one or more selected from the group consisting of 2,4-dihydroxy-benzophenone, 2-hydroxy-4-methoxy-benzophenone, 2-hydroxy-4-n-octoxy-benzophenone, 2-hydroxy-4-dodecyloxy-benzophenone, 2-hydroxy-4-octadecyloxy-benzophenone, 2,2′-dihydroxy-4-methoxy-benzophenone, 2,2′-dihydroxy-4,4′-dimethoxy-benzophenone, and 2,2′,4,4′-tetrahydroxy-benzophenone.

For example, the benzotriazole-based UV absorber may include one or more selected from the group consisting of 2-(2′-hydroxy-5-methylphenyl)benzotriazole, 2-(2′-hydroxy-3′,5′-di-t-butylphenyl)benzotriazole, 2-(2′-hydroxy-3′-t-butyl-5′-methylphenyl)benzotriazole, 2-(2′-hydroxy5′-methylphenyl)benzotriazole, 2-(2′-hydroxy-3′,5′-di-tert-butylphenyl)benzotriazole, 2-(2′-hydroxy-3′-tert-butyl-5′-methylphenyl)benzotriazole, 2-(2′-hydroxy-3′,5′-di-tert-butylphenyl)-5-chlorobenzotriazole, 2-(2′-hydroxy-3′-(3″,4″,5″,6″-tetrahydrophthalimidomethyl)-5′-methylphenyl)benzotriazole, 2,2-methylenebis(4-(1,1,3,3-tetramethylbutyl)-6-(2H-benzotriazole-2-yl)phenol), 2-(2′-hydroxy-3′-tert-butyl-5′-methylphenyl)-5-chlorobenzotriazole, 2-(2′-hydroxy-3′,5′-di-tert-butylphenyl)-5-chlorobenzotriazole, (2-(2′-hydroxy-3′,5′-di-tert-amylphenyl)-5-chlorobenzotriazole, 2-(2′-hydroxy-3′,5′-di-tert-butylphenyl)-5-chlorobenzotriazole, and (2-(2′-hydroxy-3′,5′-di-tert-amylphenyl)-5-chlorobenzotriazole.

For example, the cyanoacrylate-based UV absorber may be 2′-ethylhexyl-2-cyano-3,3-diphenylacrylate, ethyl-2-cyano-3-(3′,4′-methylenedioxyphenyl)acrylate, or a mixture thereof.

Polycarbonate Resin Composition

The polycarbonate resin composition may have an Izod impact strength of preferably 67 kgf-cm/cm or more, more preferably 68 kgf-cm/cm or more, still more preferably 68 to 80 kgf-cm/cm, still more preferably 70 to 77 kgf-cm/cm as measured at room temperature using a notched specimen having a thickness of 3.2 mm according to ASTM D256. Within this range, physical property balance may be excellent.

The polycarbonate resin composition may have an Izod impact strength of preferably 17 kgf-cm/cm or more, more preferably 20 kgf-cm/cm or more, still more preferably 20 to 35 kgf-cm/cm, still more preferably 23 to 30 kgf-cm/cm as measured at low temperature (−30° C.) using a notched specimen having a thickness of 3.2 mm according to ASTM D256. Within this range, physical property balance may be excellent.

The polycarbonate resin composition may have a heat deflection temperature of preferably 98° C. or higher, more preferably 100° C. or higher, still more preferably 102° C. or higher, still more preferably 102 to 110° C. as measured under a load of 18.6 kg using a specimen having a thickness of 6.4 mm according to ASTM D648. Within this range, physical property balance may be excellent.

The polycarbonate resin composition may preferably have a flame retardancy of grade V-0 or higher as measured using a specimen having a thickness of 0.8 mm according to the UL94 V test (vertical burning test). Within this range, impact resistance and heat resistance may be excellent, and high flame retardancy may be achieved.

Method of Preparing Polycarbonate Resin Composition

A method of preparing a polycarbonate resin composition according to the present disclosure includes a step of kneading and extruding 8 to 25% by weight of a polycarbonate (A) having a melt index (300° C., 1.2 kg) of 5 to 15 g/10 min, 45 to 77% by weight of a polycarbonate (B) having a melt index (300° C., 1.2 kg) of greater than 15 g/10 min and 25 g/10 min or less, 8 to 25% by weight of a polysiloxane-polycarbonate copolymer (C), 4.5 to 9% by weight of a room-temperature liquid phosphorus-based flame retardant (D), and 1.5 to 5.5% by weight of a phosphazene compound (E) at 200 to 350° C. and 100 to 400 rpm. In this case, impact resistance, heat resistance, and flame retardancy may be excellent.

The method of preparing a polycarbonate resin composition shares all the technical characteristics of the above-described polycarbonate resin composition. Accordingly, repeated description thereof will be omitted.

For example, the kneading and extrusion may be performed using a single-screw extruder, a twin-screw extruder, or a Banbury mixer. In this case, the composition may be uniformly dispersed, and thus compatibility may be excellent.

For example, the kneading and extrusion may be performed at a barrel temperature of 200 to 350° C., preferably 220 to 320° C., more preferably 240 to 280° C. In this case, a throughput per unit time may be appropriate, melt-kneading may be sufficiently performed, and thermal decomposition of the resin component may be prevented.

For example, the kneading and extrusion may be performed at a screw rotation rate of 100 to 400 rpm, preferably 150 to 300 rpm, more preferably 150 to 250 rpm. In this case, a throughput per unit time may be appropriate, and thus process efficiency may be excellent. Also, excessive cutting may be prevented.

Molded Article

A molded article of the present disclosure includes the polycarbonate resin composition of the present disclosure. In this case, since a post-consumer recycled polycarbonate is included in a high content, eco-friendliness may be achieved, and impact resistance, heat resistance, and flame retardancy may be excellent.

For example, the molded article may be an electrical and electronic part, an automotive part, or an industrial material.

A method of manufacturing a molded article according to the present disclosure preferably includes a step of kneading and extruding 8 to 25% by weight of a polycarbonate (A) having a melt index (300° C., 1.2 kg) of 5 to 15 g/10 min, 45 to 77% by weight of a polycarbonate (B) having a melt index (300° C., 1.2 kg) of greater than 15 g/10 min and 25 g/10 min or less, 8 to 25% by weight of a polysiloxane-polycarbonate copolymer (C), 4.5 to 9% by weight of a room-temperature liquid phosphorus-based flame retardant (D), and 1.5 to 5.5% by weight of a phosphazene compound (E) at 200 to 350° C. and 100 to 400 rpm to prepare pellets and a step of injecting the prepared pellets to manufacture a molded article. In this case, since a post-consumer recycled polycarbonate is included in a high content, eco-friendliness may be achieved, and impact resistance, heat resistance, and flame retardancy may be excellent.

For example, the prepared pellets may be subjected to injection processing after being sufficiently dried using a dehumidifying dryer or a hot air dryer.

A method of manufacturing a molded article may be used in the present disclosure without particular limitation as long as the method follows the definition of the present disclosure and conditions, methods, and devices commonly used in the art to which the present disclosure pertains are used.

In describing the polycarbonate resin composition of the present disclosure, the method of preparing the same, and the molded article including the same, it should be noted that other conditions or equipment not explicitly described herein may be appropriately selected within the range commonly practiced in the art without particular limitation.

Hereinafter, the present disclosure will be described in more detail with reference to the following preferred examples. However, these examples are provided for illustrative purposes only and should not be construed as limiting the scope and spirit of the present disclosure. In addition, it will be apparent to those skilled in the art that various changes and modifications may be made without departing from the spirit and scope of the present disclosure, and such changes and modifications are also within the scope of the appended claims.

Materials used in Examples and Comparative Examples are as follows.
A) Polycarbonate having a melt index (300° C., 1.2 kg) of 10 g/10 min measured according to ASTM D1238: Non-recycled polycarbonate (Non-recycled PC; PC1300-10, LG Chemical Co.)
B) Polycarbonate having a melt index (300° C., 1.2 kg) of 20 g/10 min measured according to ASTM D1238: Post-consumer recycled polycarbonate (PCR-PC)
C-1) Polysiloxane-polycarbonate copolymer (Si-PC): SPC8100-02 (Average size of polyorganosiloxane domains: 50 nm or more, LG Chemical Co.)
C-2) Impact modifier with a core-shell structure (MBS): Impact modifier with a core-shell structure containing methyl methacrylate-butadiene rubber (EM538, LG Chemical Co.)
D) Room-temperature liquid phosphorus-based flame retardant (BPADP): Bisphenol-A-diphenyl phosphate (FP600, ADEKA Co.)
E) Phosphazene compound: phenoxy phosphazene (HPC TP-JW01, Weihai Jinwei Chem Industry)

### EXAMPLES

According to the composition and content described in Tables 1 to 3, the ingredients were uniformly mixed using a mixer. The mixture was melted and kneaded using a twin-screw extruder (screw diameter: 26 mm, L/D=40), and then extruded at an extrusion temperature of 260° C. and a screw rotation rate of 200 rpm to obtain pellets of a polycarbonate resin composition. The pellets were dried at 80° C. for 4 hours or more, and then injected using an injection molding machine (80MT, ENGEL Co.) at a nozzle temperature of 260° C. to obtain a specimen for measuring physical properties. After leaving the specimen for 48 hours or more, the physical properties of the specimen were measured.

### TEST EXAMPLES

The properties of the specimens prepared in Examples 1 to 5 and Comparative Examples 1 to 14 were measured according to the following methods, and the results are shown in Tables 1 to 3 below.

Measurement Methods
Izod impact strength (kgf-cm/cm): Izod impact strength was measured at 23° C. (room temperature) and −30° C. (low temperature) using a notched specimen having a thickness of 3.2 mm according to ASTM D256.
Flame retardancy: Flame retardancy was evaluated using a specimen having a thickness of 0.8 mm according to the UL94 V test.
Heat deflection temperature (HDT, 4 C) Heat deflection temperature was measured measured under a load of 18.6 kg using a specimen having a thickness of 6.4 mm according to ASTM D648.

TABLE 1

| Classification | Exam- | Exam- | Exam- | Exam- | Exam- |
|---|---|---|---|---|---|
| (wt %) | ple 1 | ple 2 | ple 3 | ple 4 | ple 5 |
| A) Non- | 15 | 15 | 15 | 11 | 12 |
| recycled PC | | | | | |
| B) PCR PC | 60 | 60 | 60 | 64 | 57 |
| C-1) Si-PC | 15 | 15 | 15 | 15 | 20 |
| C-2) MBS | — | — | — | — | — |
| D) BPADP | 8 | 7 | 6 | 6 | 7 |
| E) Phosphazene | 2 | 3 | 4 | 4 | 4 |

Physical properties

| | | | | | |
|---|---|---|---|---|---|
| Impact strength at | 70 | 70 | 68 | 70 | 71 |
| room temperature | | | | | |
| (kgf · cm/cm) | | | | | |
| Impact strength at | 21 | 24 | 25 | 23 | 20 |
| low temperature | | | | | |
| (kgf · cm/cm) | | | | | |
| Flame retardancy | V-0 | V-0 | V-0 | V-0 | V-0 |
| HDT (° C.) | 101 | 102 | 105 | 105 | 100 |

TABLE 2

| Classification | Comparative | Comparative | Comparative | Comparative | Comparative | Comparative | Comparative | Comparative |
|---|---|---|---|---|---|---|---|---|
| ( wt %) | Example 1 | Example 2 | Example 3 | Example 4 | Example 5 | Example 6 | Example 7 | Example 8 |
| A) Non-recycled | 90 | 25 | 15 | 15 | 21 | 15 | 9 | 3 |
| PC | | | | | | | | |
| B) PCR PC | | 60 | 60 | 60 | 60 | 60 | 60 | 60 |
| C-1) Si-PC | | | 15 | 15 | 15 | 15 | 15 | 15 |
| C-2) MBS | | 5 | | | | | | |
| D) BPADP | 10 | 10 | 10 | | 3 | 3 | 15 | 15 |
| E) Phosphazene | | | | 10 | 1 | 7 | 1 | 7 |

Physical properties

| | | | | | | | | |
|---|---|---|---|---|---|---|---|---|
| Impact strength | 5 | 73 | 72 | 65 | 69 | 70 | 65 | 68 |
| at room | | | | | | | | |
| temperature | | | | | | | | |
| (kgf · cm/cm) | | | | | | | | |
| Impact strength | | 8 | 12 | 31 | 35 | 29 | 5 | 4 |
| at low | | | | | | | | |
| temperature | | | | | | | | |
| (kgf · cm/cm) | | | | | | | | |
| Flame | V-0 | V-0 | V-0 | V-1 | V-2 | V-1 | V-0 | V-0 |
| retardancy | | | | | | | | |
| HDT (° C.) | 97 | 95 | 96 | 110 | 116 | 108 | 82 | 75 |

TABLE 3

| Classification | Comparative | Comparative | Comparative | Comparative | Comparative | Comparative |
|---|---|---|---|---|---|---|
| (wt %) | Example 9 | Example 10 | Example 11 | Example 12 | Example 13 | Example 14 |
| A) Non-recycled | 14 | 5 | 12 | 25 | | 29 |
| PC | | | | | | |
| B) PCR PC | 60 | 60 | 60 | 60 | 60 | 60 |
| C-1) Si-PC | 15 | 15 | 15 | | 30 | 1 |
| C-2) MBS | | | | 5 | | |
| D) BPADP | 10 | 10 | 3 | 6 | 6 | 6 |
| E) Phosphazene | 1 | 10 | 10 | 4 | 4 | 4 |

Physical properties

| | | | | | | |
|---|---|---|---|---|---|---|
| Impact strength | 70 | 70 | 70 | 70 | 68 | 76 |
| at room | | | | | | |
| temperature | | | | | | |
| (kgf · cm/cm) | | | | | | |
| Impact strength | 9 | 4 | 11 | 13 | 33 | 10 |
| at low | | | | | | |
| temperature | | | | | | |
| (kgf · cm/cm) | | | | | | |
| Flame retardancy | V-0 | V-0 | V-1 | V-1 | V-1 | V-1 |
| HDT (° C.) | 99 | 85 | 103 | 100 | 103 | 105 |

As shown in Tables 1 to 3, compared to Comparative Examples 1 to 14, the polycarbonate resin compositions (Examples 1 to 5) of the present disclosure have excellent impact strength at room temperature and low temperature and excellent flame retardancy and heat deflection temperature.

Specifically, in the case of Comparative Example 1 including the non-recycled polycarbonate (A) and the room-temperature liquid phosphorus-based flame retardant (D) as in the conventional method, flame retardancy is excellent, but impact strength and heat deflection temperature are poor. In the case of Comparative Example 2 including the MBS impact modifier (C-2) and Comparative Example 3 using the room-temperature liquid phosphorus-based flame retardant (D) alone, impact strength at low temperature and heat deflection temperature are poor.

In addition, in the case of Comparative Example 4 using the phosphazene flame retardant (E) alone, impact strength at room temperature and flame retardancy are poor. In the case of Comparative Examples 5 to 11 in which the combination of the room-temperature liquid phosphorus-based flame retardant (D) and the phosphazene compound (E) is included, but the content thereof is outside the range of the present disclosure, impact strength at low temperature and/or flame retardancy are poor. In particular, Comparative Examples 7, 8, and 10 have a low heat deflection temperature.

In addition, in the case of Comparative Example 12 including the MBS impact modifier (C-2) instead of the polysiloxane-polycarbonate copolymer (C-1), impact strength at low temperature and flame retardancy are poor.

In addition, in the case of Comparative Example 13 in which the content of the polysiloxane-polycarbonate copolymer (C-1) is outside the range of the present disclosure, flame retardancy is reduced. In the case of Comparative Example 14 in which the content of the polysiloxane-polycarbonate copolymer (C-1) is less than the range of the present disclosure, impact strength at low temperature and flame retardancy are poor.

In conclusion, in the case of the polycarbonate resin composition according to the present disclosure including the non-recycled polycarbonate (A), the post-consumer recycled polycarbonate (B), the polysiloxane-polycarbonate copolymer (C), the room-temperature liquid phosphorus-based flame retardant (D), and the phosphazene compound (E) in a predetermined content ratio, impact resistance, heat resistance, and flame retardancy are excellent. In addition, despite the high content of the post-consumer recycled polycarbonate (B), impact resistance, heat resistance, and flame retardancy are improved.

What is claimed is:

1. A polycarbonate resin composition, comprising:
8 to 25% by weight of a polycarbonate (A) having a melt index (at 300° C., under a load of 1.2 kg) of 5 to 15 g/10 min;
45 to 77% by weight of a polycarbonate (B) having a melt index (at 300° C., under a load of 1.2 kg) of greater than 15 g/10 min and 25 g/10 min or less;
8 to 25% by weight of a polysiloxane-polycarbonate copolymer (C);
4.5 to 9% by weight of a room-temperature liquid phosphorus-based flame retardant (D); and
1.5 to 5.5% by weight of a phosphazene compound (E).

2. The polycarbonate resin composition according to claim 1, wherein the polycarbonate (A) is a non-recycled polycarbonate, and the polycarbonate (B) is a post-consumer recycled polycarbonate.

3. The polycarbonate resin composition according to claim 1, wherein the polysiloxane-polycarbonate copolymer (C) is a copolymer including a polysiloxane which is introduced into a polycarbonate main chain in a polymerized product of an aromatic diol compound and a carbonate precursor.

4. The polycarbonate resin composition according to claim 1, wherein the polysiloxane-polycarbonate copolymer (C) comprises:
an aromatic polycarbonate-based first repeating unit represented by Chemical Formula 1 and an aromatic polycarbonate-based second repeating unit having one or more siloxane bonds represented by Chemical Formula 2;
a repeating unit represented by Chemical Formula 3; or
a mixture thereof: 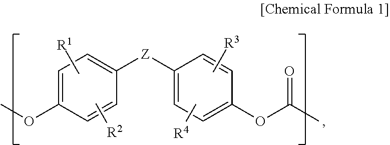
wherein R¹ to R⁴ are each independently selected from hydrogen; C₁₋₁₀ alkyl; C₁₋₁₀ alkoxy; and a halogen, and Z is selected from unsubstituted C₁₋₁₀ alkylene or C₁₋₁₀ alkylene substituted with C₁₋₆ alkyl or C₆₋₂₀ aryl; unsubstituted C₃₋₁₅ cycloalkylene or C₃₋₁₅ cycloalkylene substituted with C₁₋₁₀ alkyl; O; S; SO; SO₂; and CO, 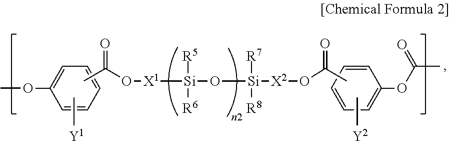
wherein X¹ and X² are each independently C₁₋₁₀ alkylene, Y¹ and Y² are each independently selected from hydrogen; C₁₋₆ alkyl; a halogen; a hydroxy group; a C₁₋₆ alkoxy group; and a C₆₋₂₀ aryl group, R⁵ to R⁸ are each independently selected from hydrogen; an unsubstituted C₁₋₁₅ alkyl; C₁₋₁₅ alkyl substituted with oxiranyl; C₁₋₁₅ alkyl substituted with a C₁₋₁₀ alkoxy group substituted with oxiranyl; C₁₋₁₅ alkyl substituted with C₆₋₂₀ aryl; a halogen; C₁₋₁₀ alkoxy;
allyl; C₁₋₁₀ haloalkyl; and C₆₋₂₀ aryl, and n2 is an integer from 30 to 120, 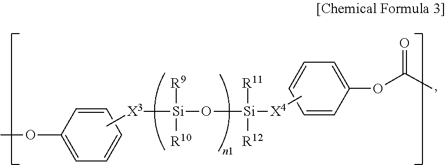
wherein X³ and X⁴ are each independently C₁₋₁₀ alkylene, R⁹ to R¹² are each independently hydrogen; an unsubstituted C₁₋₁₅ alkyl; C₁₋₁₅ alkyl substituted with oxiranyl; C₁₋₁₅ alkyl substituted with a C₁₋₁₀ alkoxy group substituted with oxiranyl; C₁₋₁₅ alkyl substituted with C₆₋₂₀ aryl; a halogen; C₁₋₁₀ alkoxy; allyl; C₁₋₁₀ haloalkyl; or C₆₋₂₀ aryl, and n1 is an integer from 30 to 120.

5. The polycarbonate resin composition according to claim 1, wherein the polysiloxane-polycarbonate copolymer (C) has siloxane domains having an average size of 20 nm or more.

6. The polycarbonate resin composition according to claim 1, wherein the room-temperature liquid phosphorus-based flame retardant (D) comprises one or more selected from the group consisting of bisphenol-A-diphenyl phosphate, triphenyl phosphate, and resorcinol bis(diphenyl phosphate).

7. The polycarbonate resin composition according to claim 1, wherein the phosphazene compound (E) comprises one or more selected from the group consisting of a cyclic phosphazene compound, an acyclic phosphazene compound, and a cross-linked phosphazene compound.

8. The polycarbonate resin composition according to claim 1, wherein a weight ratio (D:E) of the room-temperature liquid phosphorus-based flame retardant (D) to the phosphazene compound (E) is 5.5:4.5 to 9:1.

9. The polycarbonate resin composition according to claim 1, further comprising:
one or more additives selected from the group consisting of a heat stabilizer, a flame retardant aid, a lubricant, a processing aid, a plasticizer, a coupling agent, a light stabilizer, a release agent, a dispersant, an anti-dripping agent, a weathering stabilizer, an antioxidant, a compatibilizer, a pigment, a dye, an antistatic agent, an anti-wear agent, a filler, and an antibacterial agent.

10. The polycarbonate resin composition according to claim 1, wherein the polycarbonate resin composition has an Izod impact strength of 67 kgf-cm/cm or more at room temperature of 20±5° C. and an Izod impact strength of 17 kgf-cm/cm or more at low temperature of −30° C. as measured using a notched specimen having a thickness of 3.2 mm according to ASTM D256.

11. The polycarbonate resin composition according to claim 1, wherein the polycarbonate resin composition has a heat deflection temperature of 98° C. or higher as measured under a load of 18.6 kg using a specimen having a thickness of 6.4 mm according to ASTM D648.

12. The polycarbonate resin composition according to claim 1, wherein the polycarbonate resin composition has a flame retardancy of grade V-0 or higher as measured using a specimen having a thickness of 0.8 mm according to a UL94 V test.

13. A method of preparing a polycarbonate resin composition, comprising:
kneading and extruding 8 to 25% by weight of a polycarbonate (A) having a melt index (at 300° C., under a load of 1.2 kg) of 5 to 15 g/10 min, 45 to 77% by weight of a polycarbonate (B) having a melt index (at 300° C., under a load of 1.2 kg) of greater than 15 g/10 min and 25 g/10 min or less, 8 to 25% by weight of a polysiloxane-polycarbonate copolymer (C), 4.5 to 9% by weight of a room-temperature liquid phosphorus-based flame retardant (D), and 1.5 to 5.5% by weight of a phosphazene compound (E) at 200 to 350° C. and 100 to 400 rpm.

14. A molded article, comprising the polycarbonate resin composition according to claim 1.
